(19) United States
(12) Patent Application Publication
(10) Pub. No.: US 2025/0298614 A1
(43) Pub. Date: Sep. 25, 2025

(54) SYSTEM AND METHOD FOR QUEUEING IN PROCESSORS CUSTOM INSTRUCTION EXTENSION

(71) Applicant: EFINIX, INC., Cupertino, CA (US)

(72) Inventors: Joo Jie HO, Bayan Lepas (MY); Karn Ming LAU, Bayan Lepas (MY); Ching Lun YAN, Bayan Lepas (MY)

(21) Appl. No.: 18/612,718

(22) Filed: Mar. 21, 2024

(51) Int. Cl. G06F 9/30; G06F 9/38

(52) U.S. Cl. CPC G06F 9/30087; G06F 9/30181; G06F 9/3856

(57) ABSTRACT

The present invention relates to a system and method for queuing in custom instruction extension of a hardened processor (203) such as a RISC-V processor implemented on a System-on-Chip (SoC) fabric; which enables high performance for said RISC-V processor (203) when interacting with any custom accelerator (205) via custom instruction extension (207) due to the reduced latency in waiting for a response from said custom accelerator (205). The system and method of the present invention also facilities clock domain crossing between the high frequency hardened processor (203) and the lower frequency custom accelerator (205), thus simplifying the design requirements for the custom accelerator (205) to close the timing gap. Besides that, the system and method of the present invention also supports blocking and non-blocking implementations of the queueing capability without needing for updates to the register transfer level (RTL) design.

### 1. TECHNICAL FIELD OF THE INVENTION

The present invention relates to a system and method for queuing in custom instruction extension of a hardened processor such as a reduced instruction set computer V (RISC-V) processor implemented on a hardened System-on-Chip (SoC) fabric; which enables high performance for said RISC-V processor when interacting with any custom accelerator via custom instruction extension due to the reduced latency in waiting for a response from said custom accelerator. The system and method of the present invention also facilities clock domain crossing between the high frequency processor and the lower frequency custom accelerator, thus simplifying the design requirements for the custom accelerator to close the timing gap. Besides that, the system and method of the present invention also supports blocking and non-blocking implementations of the queueing capability without needing for updates to the register transfer level (RTL) design.

### 2. BACKGROUND OF THE INVENTION

One exemplary application of custom instruction involves the secure boot feature, a critical element in embedded systems tasked with authenticating legitimate software for system operation. Its primary objective is to thwart malware and malicious attacks by rigorously verifying the integrity and authenticity of software, particularly the bootloader, before loading and execution. Leveraging on cryptographic digital signatures, such as Secure Hash Algorithm 256-bit (SHA-256) and Elliptic Curve Digital Signature Algorithm (ECDSA), said application provides robust protection for firmware.

SHA-256 is a common choice in secure boot design, employed to hash firmware or configuration data and generate a fixed-size string of characters essential for creating a unique hash value in digital signature applications.

ECDSA, is a digital signature algorithm utilizing keys derived from elliptic curve cryptography (ECC), which serves to verify the legitimacy of firmware based on the SHA-256 hash result, signature, and public key stored in the embedded system. One of the most significant challenges in secure boot implementation revolves around the time-consuming computation of cryptographic algorithms such as SHA-256 and ECDSA, impacting edge device performance and boot-up time when pursued through a software approach.

The custom instruction interface in RISC-V provides the flexibility to expand the instruction set according to the user's application needs. Coupled with the programmability of field programmable gate array (FPGA), this custom instruction enables the implementation of cryptographic algorithms through a hardware approach, designed using hardware description language (HDL) like Verilog. Hardware-executed algorithms often outperform central processing units (CPUs), as FPGAs can execute specific operations in parallel, contrasting with CPUs that typically execute instructions sequentially, incurring more overhead.

Despite the hardware-executed algorithms approach being faster, cryptographic algorithms often require tens or hundreds of clock cycles, depending on the algorithm and its implementation. During the wait for results from the custom instruction extension, the RISC-V would be idle, blocked by the custom instruction command until a returned result is obtained.

YUAN JUN et al, CN113851103A, disclosed an audio noise reduction accelerator system and method based on RISC-V custom instruction set expansion. Although the prior art provides the communication between said RISC-V processor and the audio noise reduction accelerator, the custom instructions are passed directly from said RISC-V processor and said audio noise reduction accelerator. This is similar to the method of communication between said processor and custom accelerator as shown in FIG. 1. The prior art has tremendous issue on latency due to the need for said processor to wait for the returned result from said audio noise reduction accelerator before being able to perform the next task.

Hence, it would be advantageous to alleviate the shortcomings by having a system and method for queuing in custom instruction extension of a hardened processor which enables high performance for said RISC-V processor when interacting with any custom accelerator via custom instruction extension due to the reduced latency in waiting for a response from said custom accelerator.

### 3. SUMMARY OF THE INVENTION

Accordingly, it is the primary aim of the present invention to provide a system and method for queuing in processor's custom instruction extension which enables higher performance for the RISC-V processor when interacting with any custom accelerator via said custom instruction extension due to the reduced latency in waiting for a response from said custom accelerator.

It is yet another objective of the present invention to provide a system and method for queuing in processor's custom instruction extension which facilitates the clock domain crossing between the higher frequency processor and the lower frequency custom accelerator, thus simplifying the design requirements for the custom accelerator to close the timing gap.

It is yet another objective of the present invention to provide a system and method for queuing in processor's custom instruction extension which supports the blocking and non-blocking implementations without the need for updates to the register transfer level (RTL), therefore greatly reducing time and effort in designing said RTL circuitry.

Additional objects of the invention will become apparent with an understanding of the following detailed description of the invention or upon employment of the invention in actual practice.

According to the preferred embodiment of the present invention the following is provided:

A system comprising:
a semiconductor device comprising of:
   at least one hardened system-on-chip (SoC) fabric comprising of at least one hardened processor;
   at least one programmable fabric comprising of at least one custom accelerator;
said hardened processor comprises of at least one custom instruction extension configured to connect with said custom accelerator;
characterized in that
said hardened processor further comprises of at least one first memory system configured to receive at least one operation code, first source register and second source register of an R-type instruction from said hardened processor before placing said operation code, first source register and second source register on a queue before transmitting said operation code, first source register and second source register to said custom accelerator;
said hardened processor further comprises of at least one second memory system configured to receive at least one destination register from said custom accelerator before placing said destination register on a queue before said hardened processor reading said destination register when needed.

In another embodiment of the invention there is provided:
A method of reducing latency in transfer of custom instructions comprising the steps of:
(i) sending at least one R-type instruction with operation code, first source register, second source register and destination register by at least one application to at least one hardened processor's custom instruction extension;
(ii) pushing said R-type instruction by said custom instruction extension to at least one first memory system;
(iii) checking said operation code by said hardened processor;
(iv) if said operation code is a first predetermined operation code, waiting by said hardened processor for a response signal back from at least one custom accelerator before returning said response signal to said application; if said operation code is not said first predetermined operation code, returning no signal by said hardened processor to said application.

### 4. BRIEF DESCRIPTION OF THE DRAWINGS

Other aspect of the present invention and their advantages will be discerned after studying the Detailed Description in conjunction with the accompanying drawings in which:

FIG. 1 is a flow chart of the method of reducing latency in transfer of custom instructions as used in the prior arts.

FIG. 2 is a block diagram showing the system of the present invention with hardened processor with custom accelerator on different fabrics.

FIG. 3 is a flow chart of the method of the present invention showing how the embedded software sends the custom instruction and waits for response signal from custom accelerator before proceeding to process the next custom instruction.

FIG. 4 is a flow chart of the method of the present invention showing how the embedded software retrieves the response from the custom accelerator via the queue system implemented.

### 5. DETAILED DESCRIPTION OF THE DRAWINGS

In the following detailed description, numerous specific details are set forth in order to provide a thorough understanding of the invention. However, it will be understood by the person having ordinary skill in the art that the invention may be practised without these specific details. In other instances, well known methods, procedures and/or components have not been described in detail so as not to obscure the invention.

The invention will be more clearly understood from the following description of the embodiments thereof, given by way of example only with reference to the accompanying drawings, which are not drawn to scale.

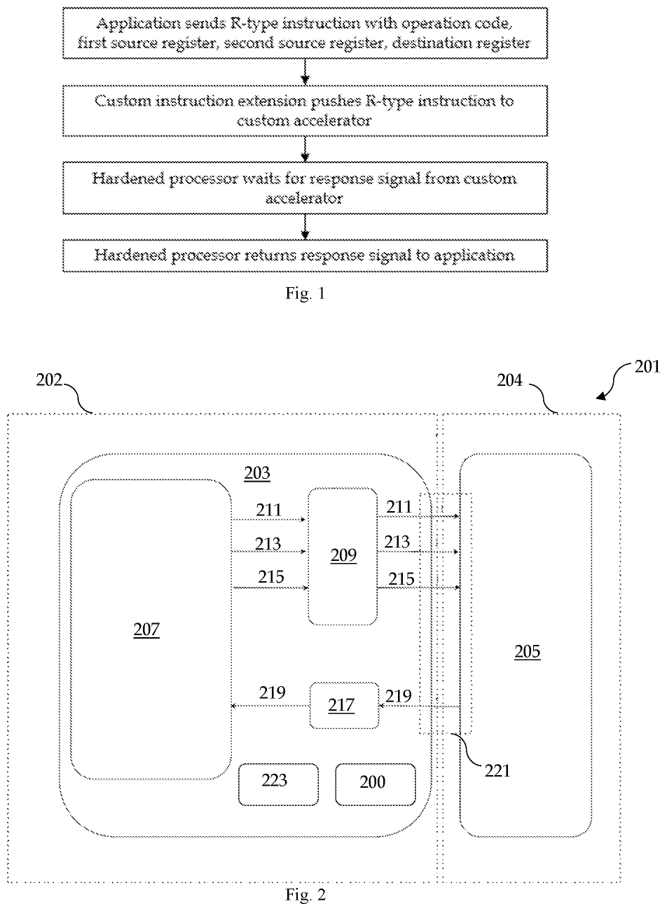

As shown in FIG. 2, it is presented a system comprising of a semiconductor device 201. The semiconductor device 201 comprises of at least one hardened system-on-chip (SoC) fabric 202 and at least one programmable fabric 204. The programmable fabric 204 may also be referred to as core fabric. The hardened SoC fabric 202 comprises of at least one hardened processor 203 while the programmable fabric 204 comprises of at least one custom accelerator 205. The custom accelerator 205, is a user implementation in HDL that is designed to cater for a specific operation that is time-consuming to run using the standard instruction for a drastic speed improvement. The custom accelerator 205 is implemented in the programmable fabric which enables flexibility for the user to implement their custom accelerator 205 that is designed with any HDL such as and not limited to Verilog or VHDL. The semiconductor device 201 can be a field programmable gate array (FPGA), ASSP, ASIC or any other suitable semiconductor devices. The hardened processor 203 can be a RISC-V. The clock speed of said programmable fabric 204 is lower than the clock speed of said hardened SoC fabric 202. The system of the present invention is simplified where the embodiment of the system can be duplicated for multi-processor design. It is possible to implement multiples of hardened processor 203 and custom accelerators 205 in a single semiconductor device 201.

The hardened processor 203 is implemented in the hardened SoC fabric 202 which runs at a higher clock frequency as the hardened SoC fabric 202 is optimized for performance. The hardened processor 203 of the present invention are able to comply with RISC-V instruction set architecture (ISA) that is implemented in dedicated circuitry within a silicon chip. The hardened processor 203 is generally empowered to perform tasks, such as printing universal asynchronous receiver or transmitter (UART) messages, while waiting, therefore significantly enhancing the performance of the hardened processor 203. The hardened processor 203 comprises of at least one custom instruction extension 207 configured to connect with said custom accelerator 205. The custom instruction extension 207, also known as custom extension, is designed to meet specific requirements for target application domains that are not supported by the standard RISC-V extension. Custom extension provides flexibility for the user to expand the instruction supported with a standard encoding space defined, i.e., R-type instruction. The custom instruction extension 207, is also designed for domain-specific optimizations, accelerations and specialized operations to improve performance and capability of said hardened processor 203. The hardened processor 203 provides a standard instruction interface 221, which may be comprising of at least one operation code 211, at least one first source register 213, at least one second source register 215 and at least one destination register 219. The standard instruction interface 221 provides standardized ports for the user to design a custom instruction on a hardened processor 203 such as a RISC-V-based processor. The hardened processor 203 further comprises of at least one first memory system 209 configured to receive at least one operation code 211 (in some cases referred to as Function ID), first source register 213 (in some cases referred to as Input 0) and second source register 215 (in some cases referred to as Input 1) of an R-type instruction from said hardened processor 203 before placing said operation code 211, first source register 213 and second source register 215 on a queue before transmitting said operation code 211, first source register 213 and second source register 215 to said custom accelerator 205. The custom accelerator can retrieve and process the instruction in its timeframe.

The hardened processor 203 further comprises of at least one second memory system 217 configured to receive at least one destination register 219 (in some cases referred to as Output 0) from said custom accelerator 205 before placing said destination register 219 on a queue before said hardened processor 203 reading said destination register 219 when needed or at its convenience. The first memory system 209 and second memory system 217 can be any suitable memory with ordering capability, such as first-in-first-out (FIFO). The first memory system 209 and second memory system 217 are configured to share the same clock as said hardened processor 203.

The system of the present invention further comprising of at least one second clock input configured to be synchronized with said custom accelerator 205 to facilitate clock domain crossing.

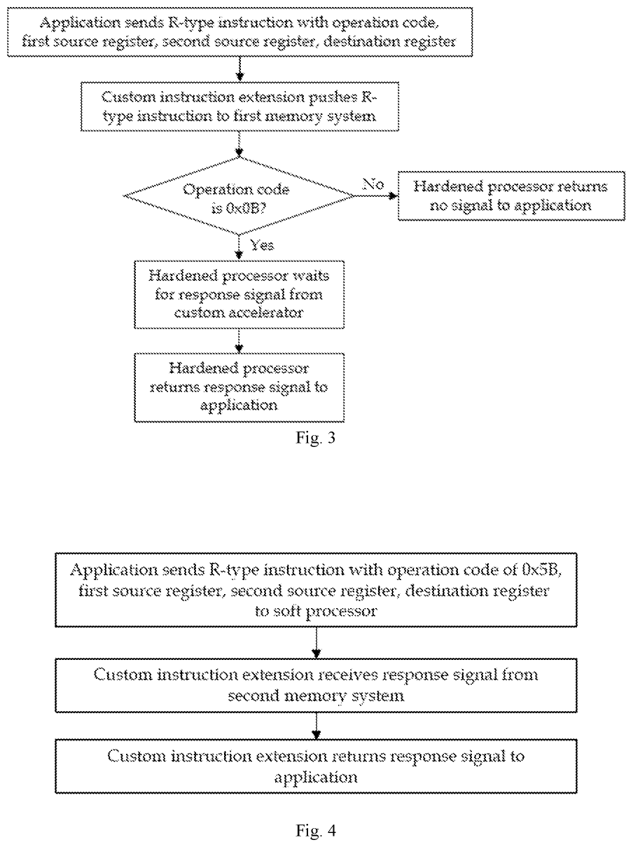

The present invention is also a method of reducing latency in the transfer of custom instructions comprising the following steps, as shown in FIG. 3. The method may be implemented in an embedded software or application 200. In step (i), at least one application 200 sends at least one R-type instruction with the required operation code 211, first source register 213, second source register 215 and destination register 219 to at least one hardened processor's 203 custom instruction extension 207. In step (ii), said custom instruction extension 207 pushes said R-type instruction to at least one first memory system 209 instead of pushing said R-type instruction directly to said custom accelerator 205. The first memory system 209 can be any suitable memory with ordering capability, such as first-in-first-out (FIFO). In step (iii), said hardened processor 203 checks said operation code 211.

To cater to various custom instruction requirements, which may either involve the hardened processor 203 waiting for the return result from the custom accelerator or retrieving the return result thereafter, both blocking and non-blocking implementations are supported without the need for updates to the register transfer level (RTL). Based on the operation code 211 or opcode provided by the application 200, the hardened processor 203 will able to determine whether said hardened processor 203 needs to wait until the response is returned from the custom accelerator 205. This greatly reduces the design effort. Therefore, in step (iv) of the method of reducing latency in transfer of custom instructions of the present invention, if said operation code 211 is a first predetermined operation code, said hardened processor 203 waits for a response signal back from at least one custom accelerator 205 before returning said response signal to said application 200. The first predetermined operation code may be 0x0B or any other suitable operation code. However, if said operation code 211 is not said first predetermined operation code, said hardened processor 203 returns no signal to said application 200, as shown in FIG. 3. As shown in FIG. 4, in step (v), said application 200 sends at least one R-type instruction with a second predetermined operation code, first source register 213, second source register 215 and destination register 217 to said hardened processor 203. The second predetermined operation code can be 0x5B or any other suitable operation code. In step (vi), said custom instruction extension 207 receives or pops response signal from at least one second memory system 217. The second memory system 217 may be any suitable memory with ordering capability, such as first-in-first-out (FIFO). In step (vii), said custom instruction extension 207 returns said response signal to said application 200 through at least one general purpose register 223.

The first memory system 209 and second memory system 217 implemented in the method of the present invention enables a queue system, whereby the hardened processor 203 is freed after sending custom instructions such as said R-type instruction and can fetch the required response from said custom accelerator 205 whenever deemed necessary. Comparing to the conventional method of without having said queue system, whereby the hardened processor 203 is blocked from processing the next custom instruction until the response is returned from the custom accelerator 205, the system and method of the present invention enables higher performance for the RISC-V processor due to the reduced latency in waiting for the response.

Moreover, the queue system placed between the hardened processor 203 and the custom accelerator(s) 205 facilitates clock domain crossing between the higher frequency of the hardened processor 203 in the hardened SoC fabric 202 and the lower frequency custom accelerator 205, thus simplifying the design requirements for the custom accelerator 205 to close the timing gap.

While the present invention has been shown and described herein in what are considered to be the preferred embodiments thereof, illustrating the results and advantages over the prior art obtained through the present invention, the invention is not limited to those specific embodiments. Thus, the forms of the invention shown and described herein are to be taken as illustrative only and other embodiments may be selected without departing from the scope of the present invention, as set forth in the claims appended hereto.

What is claimed is:

1. A system comprising:
a semiconductor device (201) comprising of:
at least one hardened system-on-chip (SoC) fabric (202) comprising of at least one hardened processor (203);
at least one programmable fabric (204) comprising of at least one custom accelerator (205);
said hardened processor (203) comprises of at least one custom instruction extension (207) configured to connect with said custom accelerator (205);
characterized in that
said hardened processor (203) further comprises of at least one first memory system (209) configured to receive at least one operation code (211), first source register (213) and second source register (215) of an R-type instruction from said hardened processor (203) before placing said operation code (211), first source register (213) and second source register (215) on a queue before transmitting said operation code (211), first source register (213) and second source register (215) to said custom accelerator (205);
said hardened processor (203) further comprises of at least one second memory system (217) configured to receive at least one destination register (219) from said custom accelerator (205) before placing said destination register (219) on a queue before said hardened processor (203) reading said destination register (219) when needed.

2. The system as claimed in claim 1, further comprising of at least one second clock input configured to be synchronized with said custom accelerator (205) to facilitate clock domain crossing.

3. The system as claimed in claim 1, wherein said semiconductor device (201) is a field programmable gate array (FPGA), ASSP, ASIC or any other suitable semiconductor devices.

4. The system as claimed in claim 1, wherein said hardened processor (203) is a reduced instruction set computer V (RISC-V).

5. The system as claimed in claim 1, wherein said first memory system (209) and second memory system (217) are any suitable memory with ordering capability, such as first-in-first-out (FIFO).

6. The system as claimed in claim 1, wherein said first memory system (209) and second memory system (217) are configured to share the same clock as said hardened processor (203).

7. The system as claimed in claim 1, wherein the clock speed of said programmable fabric (204) is lower than the clock speed of said hardened SoC fabric (202).

8. The system as claimed in claim 1, wherein said hardened processor (203) is a non-standard extension designed for domain-specific optimizations, accelerations and specialized operations.

9. A method of reducing latency in transfer of custom instructions comprising the steps of:
(i) sending at least one R-type instruction with operation code (211), first source register (213), second source register (215) and destination register (219) by at least one application (200) to at least one hardened processor's (203) custom instruction extension (207);
(ii) pushing said R-type instruction by said custom instruction extension (207) to at least one first memory system (209);
(iii) checking said operation code (211) by said hardened processor (203);
(iv) if said operation code (211) is a first predetermined operation code, waiting by said hardened processor (203) for a response signal back from at least one custom accelerator (205) before returning said response signal to said application (200); if said operation code (211) is not said first predetermined operation code, returning no signal by said hardened processor (203) to said application (200).

10. The method of reducing latency in transfer of custom instructions as claimed in claim 9, further comprising the steps of:
v. sending at least one R-type instruction with a second predetermined operation code, first source register, second source register and destination register by said application (200) to said hardened processor (203);
vi. receiving response signal by said custom instruction extension (207) from at least one second memory system (217);
vii. returning said response signal by said custom instruction extension (207) to said application (200).

11. The method of reducing latency in transfer of custom instructions as claimed in claim 9, wherein said first predetermined operation code is 0x0B.

12. The method of reducing latency in transfer of custom instructions as claimed in claim 10, wherein said second predetermined operation code is 0x5B.

13. The method of reducing latency in transfer of custom instructions as claimed in claim 9, wherein said first memory system (209) is any suitable memory with ordering capability, such as first-in-first-out (FIFO).

14. The method of reducing latency in transfer of custom instructions as claimed in claim 10, said second memory system (217) is any suitable memory with ordering capability, such as first-in-first-out (FIFO).
